(19) United States
(12) Patent Application Publication
(10) Pub. No.: US 2007/0111129 A1
(43) Pub. Date: May 17, 2007

(54) Toner compositions

(75) Inventors: Raj D. Patel, Oakville (CA); Daryl W. Vanbesien, Burlington (CA); Edward G. Zwartz, Mississauga (CA); Rosa M. Duque, Brampton (CA)

Correspondence Address: OLIFF & BERRIDGE, PLC, P.O. BOX 19928, ALEXANDRIA, VA, 22320, US

(73) Assignee: XEROX CORPORATION, Stamford, CT (US)

(21) Appl. No.: 11/272,720

(22) Filed: Nov. 15, 2005

(51) Int. Cl. G03G 9/08

(52) U.S. Cl. 430/108.8; 430/109.1; 430/137.14; 430/110.2; 430/109.3

(57) ABSTRACT

A toner composition includes a resin substantially free of cross linking and having a weight average molecular weight of from about 50,000 to about 1,000,000, a wax, a colorant, and a coagulant.

### TECHNICAL FIELD

This disclosure is generally directed to toner compositions and processes. More specifically, this disclosure is directed to toner compositions and processes, such as emulsion aggregation toner processes, for preparing toner compositions comprising a high molecular weight non cross linked resin such as having a weight average molecular weight of at least 50,000, a wax, and a colorant.

### RELATED APPLICATIONS

Commonly assigned, U.S. patent application Ser. No. 11/003,176 filed Dec. 3, 2004, describes toner compositions comprising a non cross linked resin, a cross linked resin, a wax, a pigment dispersion, and a coagulant of a poly metal halide providing a toner having selected characteristics such as excellent fusing characteristics.

Commonly assigned, U.S. patent application Ser. No. 11/003,966 filed Dec. 3, 2004, describes toner processes comprising developing an image on a document having a toner composition applied to the document, wherein the toner composition comprises a resin substantially free of cross linking, a cross linked resin, a wax, and a colorant; and wherein the developed document possesses the characteristic of resistance to adverse effects of electron beam irradiation. In embodiments, the processes further include, during fusing, migrating the wax and cross linked resin to the surface of the toner particles thereby imparting protection to the toner particles against exposure to elevated temperatures.

Commonly assigned, U.S. patent application Ser. No. 11/003,297 filed Dec. 3, 2004, describes toner compositions comprising a non cross linked resin; a cross linked resin; a wax; and a conductive colorant, wherein the compositions have an optimized colorant loading to provide image quality in combination with alleviation or elimination of undesirable effects associated with inductive charging.

Commonly assigned, U.S. patent application Ser. No. 11/003,256 filed Dec. 3, 2004, describes a toner composition comprising a binder, colorant, and a charge control surface additive mixture comprising a mixture of a first titanium dioxide possessing a first conductivity and a second titanium dioxide possessing a second conductivity and which second conductivity is dissimilar from the first conductivity; wherein the mixture of the first titanium dioxide and the second titanium dioxide is selected in a ratio sufficient to impart a selected triboelectric charging characteristic to the toner composition.

Commonly assigned, U.S. patent application Ser. No. 11/003,581 filed Dec. 3, 2004, discloses a toner composition comprising a resin substantially free of cross linking, a cross linked resin, a wax, and a colorant. In embodiments, the toner composition can be made by mixing a resin substantially free of cross linking and a cross linked resin in the presence of a wax, a colorant, and a coagulant to provide toner size aggregates, adding additional resin substantially free of cross linking to the formed aggregates thereby providing a shell over the formed aggregates, heating the shell covered aggregates to form toner, and optionally, isolating the toner.

The appropriate components and process aspects of each of the foregoing may be selected for the present disclosure in embodiments thereof, and the entire disclosure of the above-mentioned applications are totally incorporated herein by reference.

### REFERENCES

U.S. Pat. No. 6,447,974 describes in the Abstract a process for the preparation of a latex polymer by (i) preparing or providing a water aqueous phase containing an anionic surfactant in an optional amount of less than or equal to about 20 percent by weight of the total amount of anionic surfactant used in forming the latex polymer; (ii) preparing or providing a monomer emulsion in water which emulsion contains an anionic surfactant; (iii) adding about 50 percent or less of said monomer emulsion to said aqueous phase to thereby initiate seed polymerization and to form a seed polymer, said aqueous phase containing a free radical initiator; and (iv) adding the remaining percent of said monomer emulsion to the composition of (iii) and heating to complete an emulsion polymerization thus forming a latex polymer.

U.S. Pat. No. 6,413,692 describes in the Abstract a process comprising coalescing a plurality of latex encapsulated colorants and wherein each of said encapsulated colorants are generated by miniemulsion polymerization.

U.S. Pat. No. 6,309,787 describes in the Abstract a process comprising aggregating a colorant encapsulated polymer particle containing a colorant with colorant particles and wherein said colorant encapsulated latex is generated by a miniemulsion polymerization.

U.S. Pat. No. 6,294,306 describes in the Abstract toners which include one or more copolymers combined with colorant particles or primary toner particles and a process for preparing a toner comprising (i) polymerizing an aqueous latex emulsion comprising one or more monomers, an optional nonionic surfactant, an optional anionic surfactant, an optional free radical initiator, an optional chain transfer agent, and one or more copolymers to form emulsion resin particles having the one or more copolymers dispersed therein; (ii) combining the emulsion resin particle with colorant to form statically bound aggregated composite particles; (iii) heating the statically bound aggregated composite particles to form toner; and (iv) optionally isolating the toner.

U.S. Pat. No. 6,130,021 describes in the Abstract a process involving the mixing of a latex emulsion containing resin and a surfactant with a colorant dispersion containing a nonionic surfactant, and a polymeric additive and adjusting the resulting mixture pH to less than about 4 by the addition of an acid and thereafter heating at a temperature below about, or equal to about, the glass transition temperature (Tg) of the latex resin, subsequently heating at a temperature above about, or about equal to, the Tg of the latex resin, cooling to about room temperature, and isolating the toner product.

U.S. Pat. No. 5,928,830 describes in the Abstract a process for the preparation of a latex comprising a core polymer and a shell thereover and wherein the core polymer is generated by (A) (i) emulsification and heating of the polymerization reagents of monomer, chain transfer agent, water, surfactant, and initiator; (ii) generating a seed latex by the aqueous emulsion polymerization of a mixture comprised of part of the (i) monomer emulsion, from about 0.5 to about 50 percent by weight, and a free radical initiator, and which polymerization is accomplished by heating, and, wherein the reaction of the free radical initiator and monomer produces a seed latex containing a polymer; (iii) heating and adding to the formed seed particles of (ii) the remaining monomer emulsion of (I), from about 50 to about 99.5 percent by weight of monomer emulsion of (i) and free radical initiator; (iv) whereby there is provided said core polymer; and (B) forming a shell thereover said core generated polymer and which shell is generated by emulsion polymerization of a second monomer in the presence of the core polymer, which emulsion polymerization is accomplished by (i) emulsification and heating of the polymerization reagents of monomer, chain transfer agent, surfactant, and an initiator; (ii) adding a free radical initiator and heating; (iii) whereby there is provided said shell polymer.

U.S. Pat. No. 5,869,558 describes in the Abstract dielectric black particles for use in electrophoretic image displays, electrostatic toner or the like, and the corresponding method of manufacturing the same. The black particles are latex particles formed by a polymerization technique, wherein the latex particles are stained to a high degree of blackness with a metal oxide.

U.S. Pat. No. 5,869,216 describes in the Abstract a process for the preparation of toner comprising blending an aqueous colorant dispersion and a latex emulsion containing resin; heating the resulting mixture at a temperature below about the glass transition temperature (Tg) of the latex resin to form toner sized aggregates; heating said resulting aggregates at a temperature above about the Tg of the latex resin to effect fusion or coalescence of the aggregates; redispersing said toner in water at a pH of above about 7; contacting the resulting mixture with a metal halide or salt, and then with a mixture of an alkaline base and a salicylic acid, a catechol, or mixtures thereof at a temperature of from about 25 degrees C. to about 80 degrees C.; and optionally isolating the toner product, washing, and drying. Additional patents of interest include U.S. Pat. Nos. 5,766,818; 5,344,738; and 4,291,111.

The disclosures of each of the foregoing U.S. Patents are hereby incorporated by reference herein in their entireties. The appropriate components and process aspects of the each of the foregoing U.S. Patents may also be selected for the present compositions and processes in embodiments thereof.

### BACKGROUND

For both black and color prints, a small particle size toner is known to improve the image quality of the prints. High speed black and white printers require toner particles that can provide a matte finish in an oil-less fuser system with a low minimum fixing temperature (MFT) to enable high speed printing and at the same time achieve superior image quality in the resultant printed product.

It is known that toners containing carbon black or other conductive pigments are susceptible to inductive charging in high electric fields. As a result, a large amount of wrong-sign toner is created, which leads to excessive background on the photoreceptor, especially with machines employing contact dual-component development. This inductive background has low transfer efficiency and may cause two fundamental problems: poor image quality due to some background toner transferring onto the media, and excessive amount of wasted toner, since most of the un-transferred background toner is directed straight to the waste bottle. Under severe conditions, as much as about 80% of the total toner consumed can be lost to inductive background.

There remains a need for an improved toner composition and process, which overcome or alleviate the above-described and other problems experienced in the art. There further remains a need for a toner composition suitable for high speed printing, particularly high speed monochrome printing that can provide excellent release and hot offset characteristics, minimum fixing temperature, and suitable small toner particle size characteristics.

### SUMMARY

The present disclosure addresses these and other needs, by providing improved toner compositions and preparation processes for making emulsion/aggregation toner compositions. The disclosure provides improved toner composition materials, thereby providing excellent toner release, hot offset characteristics, and minimum fixing temperature.

In embodiments, the present disclosure provides toner compositions that include a high molecular weight non cross linked resin. The toner compositions can include a core material comprising the high molecular weight non cross linked resin, a wax, and a colorant, and a shell material of the high molecular weight non cross linked resin. By using the high molecular weight non cross linked resin, the gloss of the toner is reduced, the hot offset requirement is also achieved, and a lower minimum fusing temperature is provided. The toner composition, and production processes, are particularly suited for providing and preparing matte, monochrome toners.

In an embodiment, the present disclosure provides a toner comprising:

a resin substantially free of cross linking and having a weight average molecular weight of from about 50,000 to about 1,000,000;

a wax;

a colorant; and

a coagulant.

In another embodiment, the present disclosure provides a toner process comprising:

mixing a resin substantially free of cross linking and having a weight average molecular weight of from about 50,000 to about 1,000,000, a wax, a colorant, and a coagulant to provide toner size aggregates;

optionally, adding additional resin substantially free of cross linking and having a weight average molecular weight of from about 50,000 to about 1,000,000 to the formed aggregates thereby providing a shell over the formed aggregates;

heating the shell covered aggregates to form toner; and

optionally, isolating the toner.

In embodiments, the toner compositions do not include any cross linked resin, or do not include a significant amount of cross linked resin.

### EMBODIMENTS

Toner compositions will now be described comprising a high molecular weight non cross linked resin, a wax, and a colorant; and a process for preparing a toner comprising mixing a high molecular weight non cross linked resin, a wax, a colorant, and a coagulant to provide toner size aggregates; adding additional resin latex to the formed aggregates thereby providing a shell over the formed aggregates; heating the shell covered aggregates to form toner; and, optionally, isolating the toner. In embodiments, the toner process includes providing an anionic surfactant in an amount of for example about 0.01% to about 20% by weight based upon a total weight of the reaction mixture; wherein for example the anionic surfactant is selected from the group consisting of sodium dodecylsulfate, sodium dodecylbenzene sulfonate, sodium dodecylnaphthalene sulfate, dialkyl benzenealkyl, sulfates, sulfonates, adipic acid, hexa decyldiphenyloxide disulfonate, or mixtures thereof. In further embodiments, the shell thus formed has, for example, a thickness of about 0.3 to about 0.8 micrometers.

Latex Resin or Polymer

Illustrative examples of latex resins or polymers that can be suitably selected for forming the high molecular weight non cross linked resin include, but are not limited to, styrene acrylates, styrene methacrylates, butadienes, isoprene, acrylonitrile, acrylic acid, methacrylic acid, beta-carboxy ethyl arylate, polyesters, known polymers such as poly(styrene-butadiene), poly(methyl styrene-butadiene), poly(methyl methacrylate-butadiene), poly(ethyl methacrylate-butadiene), poly(propyl methacrylate-butadiene), poly(butyl methacrylate-butadiene), poly(methyl acrylate-butadiene), poly(ethyl acrylate-butadiene), poly(propyl acrylate-butadiene), poly(butyl acrylate-butadiene), poly(styrene-isoprene), poly(methyl styrene-isoprene), poly(methyl methacrylate-isoprene), poly(ethyl methacrylate-isoprene), poly(propyl methacrylate-isoprene), poly(butyl methacrylate-isoprene), poly(methyl acrylate-isoprene), poly(ethyl acrylate-isoprene), poly(propyl acrylate-isoprene), poly(butyl acrylate-isoprene); poly(styrene-propyl acrylate), poly(styrene-butyl acrylate), poly(styrene-butadiene-acrylic acid), poly(styrene-butadiene-methacrylic acid), poly(styrene-butyl acrylate-acrylic acid), poly(styrene-butyl acrylate-methacrylic acid), poly(styrene-butyl acrylate-acrylonitrile), poly(styrene-butyl acrylate-acrylonitrile-acrylic acid), styrene/butyl acrylate/carboxylic acid terpolymers, styrene/butyl acrylate/beta-carboxy ethyl acrylate terpolymers, and the like.

In embodiments, for example, the resin may be selected to contain a carboxylic acid group selected, for example, from the group comprised of, but not limited to, acrylic acid, methacrylic acid, itaconic acid, beta carboxy ethyl acrylate (beta CEA), fumaric acid, maleic acid, and cinnamic acid, and wherein, for example, a carboxylic acid is selected in an amount of form about 0.1 to about 10 weight percent of the total weight of the resin.

In embodiments, the selected non cross linked resin is a high molecular weight resin. The term “high molecular weight” refers to, for example, non cross linked resins having a weight average molecular weight of at least about 50,000, such as from about 50,000 to about 5,000,000 or about 10,000,000. In embodiments, the high molecular weight non cross linked resin has a weight average molecular weight of from about 50,000 to about 1,000,000, such as from about 50,000 or from about 55,000 or from about 60,000 to about 250,000 or to about 500,000 or to about 750,000. In some embodiments, the high molecular weight non cross linked resin has a weight average molecular weight of from about 50,000 to about 500,000, such as from about 50,000 to about 150,000, from about 60,000 to about 300,000, from about 70,000 to about 200,000, or from about 75,000 to about 150,000. In embodiments, the high molecular weight non cross linked resin has a number average molecular weight of from about 10,000 to about 100,000, such as from about 10,000 to about 50,000, or from about 15,000 to about 30,000. These high molecular weight non cross linked resins are thus distinguished from low molecular weight non cross linked resins used in the art, which typically have a weight average molecular weight of only from about 30,000 to about 40,000, as evidenced by the cross-referenced applications discussed above.

In the present disclosure, the high molecular weight non cross linked resin is substantially free of cross linking. As used herein, “substantially free of cross linking” (also referred to herein as a non cross linked resin) refers for example to a resin having less than about 10 percent, such as less than about 5 percent, less than about 1 percent, or less than about 0.1 percent, cross linking between polymer chains. Thus, in embodiments it is preferred that the resin latex is substantially free of cross-linking as to any functional groups that may be present in the resin, meaning that the entire resin latex has less than about 10 percent, such as less than about 5 percent, less than about 1 percent, or less than about 0.1 percent, cross linking.

In embodiments, the high molecular weight non cross linked resin is the only binder resin present in the toner compositions. Thus, for example, where the toner composition does not include a polymer shell around the aggregate particles, the binder resin of the toner composition consists essentially of, or consists of, the high molecular weight non cross linked resin. In these embodiments, the toner composition does not include other resins, such as lower molecular weight non cross linked resins or any cross linked resins, besides the specified high molecular weight non cross linked resin. For example, such lower molecular weight non cross linked resins or any cross linked resins are not present at all, or are present in an amount that does not significantly affect the toner properties, such as in a total amount of from 0 to about 1 percent or to about 2 percent by weight, such as in a total amount of from 0 to about 0.5 percent by weight, based on a total weight of the toner composition. Alternatively, in embodiments, such as where the toner composition does include a polymer shell around the aggregate particles, the binder resin of the core of the toner composition consists essentially of, or consists of, the high molecular weight non cross linked resin, as specified above. The shell of the toner particles can likewise can consist essentially of, or consist of, the high molecular weight non cross linked resin. In this embodiment, the core and shell resins can be the same resin, that is, the same types and amounts of monomers, the same molecular weight, and the like, or they can be different resins, that is different in at least one aspect such as different types and/or amounts of constituent monomers, different molecular weight, different properties, or the like. In still other embodiments, the core and/or shell resins, when present, can include other resins in addition to the high molecular weight non cross linked resin, such as a low molecular weight non cross linked resin (where “low molecular weight” refers to a weight average molecular weight of less than about 50,000), a cross linked resin, mixtures thereof, and the like.

As will be apparent, the properties of the high molecular weight non cross linked resin can be suitably adjusted by adjusting the types and amounts of constituent monomers, adjusting the type and amount of chain transfer agents, and the like. For example, adjusting the ratio of constituent monomers can adjust the toner glass transition temperature (Tg), which in turn can effect toner blocking properties, fusing properties, and the like.

Likewise, adjusting the amount of chain transfer agent used in forming the resin latexes used for the core and/or shell resin components, can adjust resin properties. For example, using different amounts of chain transfer agent, such as dodecanethiol, when forming the resin latex, can change the resin's properties such as molecular weight, glass transition temperature, and the like. For example, increasing the amount of chain transfer agent in forming the core resin latex, can decrease the molecular weight due to chain termination during polymerization; while decreasing the amount of chain transfer agent in forming the shell resin latex will increase the molecular weight, which can aid in toner blocking properties.

The monomer units used to form the resin latex or latexes can be suitably polymerized by any known process. For example, the monomer units can be polymerized, in a starve fed semi-continuous emulsion polymerization process, a standard emulsion polymerization process, or the like, to provide the resin latex. Such polymerizations can be carried out, for example, in the presence of an initiator, a chain transfer agent (CTA), and surfactant.

In embodiments, the resin or polymer used as the high molecular weight non cross linked resin is a styrene/butyl acrylate/beta-carboxyethylacrylate terpolymer. In other embodiments, the resin or polymer can be styrene/butyl acrylate/acrylic acid terpolymer, styrene/butyl acrylate/methacrylic acid terpolymer, styrene/butyl acrylate/itaconic acid terpolymer, styrene/butyl acrylate/furmaic acid terpolymer, styrene/butadiene/beta-carboxyethylacrylate terpolymer, styrene/butadiene/methacrylic acid terpolymer, styrene/butadiene/acrylic acid terpolymer, styrene/isoprene/beta-carboxyethylacrylate terpolymer and the like.

In embodiments, the resin substantially free of cross linking comprises styrene:butylacrylate:beta-carboxy ethyl acrylate wherein, for example, the non cross linked resin monomers are present in an amount of about 70% to about 90% styrene, about 10% to about 30% butylacrylate, and about 0.05 parts per hundred to about 10 parts per hundred beta-CEA, such as about 3 parts per hundred beta-CEA, by weight based upon the total weight of the monomers. However, the component ratios are not limited to these ranges, and other amounts can be used.

In a feature herein, the non cross linked resin comprises about 73% to about 85% styrene, about 27% to about 15% butylacrylate, and about 1.0 part per hundred to about 5 parts per hundred beta-CEA, by weight based upon the total weight of the monomers although the compositions and processes are not limited to these particular types of monomers or ranges. In another feature, the non cross linked resin comprises about 81.7% styrene, about 18.3% butylacrylate, and about 3.0 parts per hundred beta-CEA, by weight based upon the total weight of the monomers.

The initiator may be, for example, but is not limited to, sodium, potassium or ammonium persulfate and may be present in the range of, for example, about 0.5 to about 3.0 percent based upon the weight of the monomers, although not limited. The chain transfer agent may be present in an amount of from about 0.5 to about 5.0 percent by weight based upon the combined weight of the monomers, although not limited. In embodiments, the surfactant is an anionic surfactant present in the range of about 0.7 to about 5.0 percent by weight based upon the weight of the aqueous phase, although not limited to this type or range.

For example, the monomers can be polymerized under starve fed conditions as referred to in U.S. Pat. Nos. 6,447,974, 6,576,389, 6,617,092, and 6,664,017, the entire disclosure of which are incorporated herein by reference, to provide latex resin particles having a diameter in the range of about 100 to about 300 nanometers.

In embodiments, the onset glass transition temperature (Tg) of the non cross linked resin can be in the range of, for example, from about 48° C. to about 62° C., or about 50° C. to about 60° C. such as about 53° C. to about 60° C., although not limited.

Surfactants

For example, surfactants in amounts of about 0.01 to about 20, or about 0.1 to about 15 weight percent of the reaction mixture in embodiments can be used. Examples of suitable surfactants include, for example, nonionic surfactants such as dialkylphenoxypoly(ethyleneoxy) ethanol, available from Rhone-Poulenc as IGEPAL CA-210™, IGEPAL CA-520™, IGEPAL CA-720™, IGEPAL CO-890™, IGEPAL CO-720™, IGEPAL CO-290™, IGEPAL CA-210.™, ANTAROX890™ and ANTAROX 897.™ For example, an effective concentration of the nonionic surfactant is, in embodiments, from about 0.01 percent to about 10 percent by weight, or from about 0.1 percent to about 5 percent by weight of the reaction mixture.

Examples of anionic surfactants being include sodium dodecylsulfate (SDS), sodium dodecylbenzene sulfonate, sodium dodecylnaphthalene sulfate, dialkyl benzenealkyl, sulfates and sulfonates, adipic acid, available from Aldrich, NEOGEN R.™, NEOGEN SC.™, available from Kao, Dowfax 2A1 (hexa decyldiphenyloxide disulfonate) and the like, among others. For example, an effective concentration of the anionic surfactant generally employed can be from about 0.01 percent to about 10 percent by weight, or from about 0.1 percent to about 5 percent by weight of the reaction mixture

One or more bases can also be used to increase the pH and hence ionize the aggregate particles thereby providing stability and preventing the aggregates from growing in size. Examples of bases that can be selected include sodium hydroxide, potassium hydroxide, ammonium hydroxide, cesium hydroxide and the like, among others.

Additional surfactants can also optionally be added to the aggregate suspension prior to or during the coalescence. Such additional surfactants can be used, for example, to prevent the aggregates from growing in size, or for stabilizing the aggregate size, with increasing temperature. Suitable additional surfactants can be selected from anionic surfactants such as sodium dodecylbenzene sulfonate, sodium dodecylnaphthalene sulfate, dialkyl benzenealkyl, sulfates and sulfonates, adipic acid, available from Aldrich, NEOGEN R.™, NEOGEN SC™ available from Kao, and the like, among others. These surfactants can also be selected from nonionic surfactants such as polyvinyl alcohol, polyacrylic acid, methalose, methyl cellulose, ethyl cellulose, propyl cellulose, hydroxy ethyl cellulose, carboxy methyl cellulose, polyoxyethylene cetyl ether, polyoxyethylene lauryl ether, polyoxyethylene octyl ether, polyoxyethylene octylphenyl ether, polyoxyethylene oleyl ether, polyoxyethylene sorbitan monolaurate, polyoxyethylene stearyl ether, polyoxyethylene nonylphenyl ether, dialkylphenoxypoly(ethyleneoxy) ethanol, available from Rhone-Poulenac as IGEPAL CA-210™, IGEPAL CA-520™, IGEPAL CA-720™, IGEPAL CO-890™, IGEPAL CO-720™, IGEPAL CO-290™, IGEPAL CA-210™, ANTAROX890™ and ANTAROX897™. An effective amount of the anionic or nonionic surfactant generally employed as an aggregate size stabilization agent is, for example, about 0.01 percent to about 10 percent or about 0.1 percent to about 5 percent, by weight of the reaction mixture.

Examples of the acids that can be utilized include, for example, nitric acid, sulfuric acid, hydrochloric acid, acetic acid, citric acid, trifluoro acetic acid, succinic acid, salicylic acid and the like, and which acids are in embodiments utilized in a diluted form in the range of about 0.5 to about 10 weight percent by weight of water or in the range of about 0.7 to about 5 weight percent by weight of water.

Wax

The toner composition also includes at least one wax. For example, waxes suitable for the present toner compositions include, but are not limited to, alkylene waxes such as alkylene wax having about 1 to about 25 carbon atoms, such as polyethylene, polypropylene or mixtures thereof. The wax can be present, for example, in an amount of about 6% to about 15% by weight based upon the total weight of the composition. Examples of waxes include those as illustrated herein, such as those of the aforementioned co-pending applications, polypropylenes and polyethylenes commercially available from Allied Chemical and Petrolite Corporation, wax emulsions available from Michaelman Inc. and the Daniels Products Company, Epolene N-15™ commercially available from Eastman Chemical Products, Inc., Viscol 550-P™, a low weight average molecular weight polypropylene available from Sanyo Kasei K.K., and similar materials. The commercially available polyethylenes possess, it is believed, a molecular weight (Mw) of about 100 to about 3,000, and the commercially available polypropylenes are believed to possess a molecular weight of about 1,000 to about 10,000. Examples of functionalized waxes include amines, amides, for example Aqua Superslip 6550™, Superslip 6530™ available from Micro Powder Inc., fluorinated waxes, for example Polyfluo 190™, Polyfluo 200™, Polyfluo 523XF™, Aqua Polyfluo 411™, Aqua Polysilk 19™, Polysilk 14™ available from Micro Powder Inc., mixed fluorinated, amide waxes, for example Microspersion 19™ also available from Micro Powder Inc., imides, esters, quaternary amines, carboxylic acids or acrylic polymer emulsion, for example Joncryl 74™, 89™, 130™, 537™, and 538™, all available from SC Johnson Wax, chlorinated polypropylenes and polyethylenes available from Allied Chemical and Petrolite Corporation and SC Johnson Wax.

In embodiments, the wax comprises a wax in the form of a dispersion comprising, for example, a wax having a particle diameter of about 100 nanometers to about 500 nanometers, water, and an anionic surfactant. In embodiments, the wax can be included in amounts such as about 6 to about 15 weight percent. In embodiments, the wax comprises polyethylene wax particles, such as Polywax 850, commercially available from Baker Petrolite, although not limited thereto, having a particle diameter in the range of about 100 to about 500 nanometers, although not limited. The surfactant used to disperse the wax can be an anionic surfactant, although not limited thereto, such as, for example, Neogen RK™ commercially available from Kao Corporation or TAYCAPOWER BN2060 commercially available from Tayca Corporation.

Colorant

The toner composition also includes at least one colorant, such as a dye and/or a pigment. For example, colorants include pigment, dye, mixtures of pigment and dye, mixtures of pigments, mixtures of dyes, and the like. For simplicity, the term “colorant” refers for example to such organic soluble dyes, pigments, and mixtures, unless specified as a particular pigment or other colorant component. In embodiments, the colorant comprises carbon black, magnetite, black, cyan, magenta, yellow, red, green, blue, brown, or mixtures thereof, in an amount of about 1% to about 25%, such as about 2% or about 5% to about 15% or about 20%, by weight based upon the total weight of the composition. It is to be understood that other useful colorants will become readily apparent based on the present disclosures.

In general, useful colorants include, but are not limited to, black colorants such as Paliogen Black L9984 (BASF), Pigment Black K801 (BASF) and carbon blacks such as REGAL 330 (Cabot), REGAL 660 (Cabot), Carbon Black 5250 and 5750 (Columbian Chemicals), and the like or mixtures thereof.

Additional useful colorants include pigments in water based dispersions such as those commercially available from Sun Chemical, for example SUNSPERSE BHD 6011X (Blue 15 Type), SUNSPERSE BHD 9312X (Pigment Blue 15 74160), SUNSPERSE BHD 6000X (Pigment Blue 15:3 74160), SUNSPERSE GHD 9600X and GHD 6004X (Pigment Green 7 74260), SUNSPERSE QHD 6040X (Pigment Red 122 73915), SUNSPERSE RHD 9668X (Pigment Red 185 12516), SUNSPERSE RHD 9365X and 9504X (Pigment Red 57 15850:1, SUNSPERSE YHD 6005X (Pigment Yellow 83 21108), FLEXIVERSE YFD 4249 (Pigment Yellow 17 21105), SUNSPERSE YHD 6020X and 6045X (Pigment Yellow 74 11741), SUNSPERSE YHD 600X and 9604X (Pigment Yellow 14 21095), FLEXIVERSE LFD 4343 and LFD 9736 (Pigment Black 7 77226) and the like or mixtures thereof. Other useful water based colorant dispersions include those commercially available from Clariant, for example, HOSTAFINE Yellow GR, HOSTAFINE Black T and Black TS, HOSTAFINE Blue B2G, HOSTAFINE Rubine F6B and magenta dry pigment such as Toner Magenta 6BVP2213 and Toner Magenta E02 which can be dispersed in water and/or surfactant prior to use.

Other useful colorants include, for example, magnetites, such as Mobay magnetites MO8029, MO8960; Columbian magnetites, MAPICO BLACKS and surface treated magnetites; Pfizer magnetites CB4799, CB5300, CB5600, MCX6369; Bayer magnetites, BAYFERROX 8600, 8610; Northern Pigments magnetites, NP-604, NP-608; Magnox magnetites TMB-100 or TMB-104; and the like or mixtures thereof. Specific additional examples of pigments include phthalocyanine HELIOGEN BLUE L6900, D6840, D7080, D7020, PYLAM OIL BLUE, PYLAM OIL YELLOW, PIGMENT BLUE 1 available from Paul Uhlrich & Company, Inc., PIGMENT VIOLET 1, PIGMENT RED 48, LEMON CHROME YELLOW DCC 1026, E.D. TOLUIDINE RED and BON RED C available from Dominion Color Corporation, Ltd., Toronto, Ontario, NOVAPERM YELLOW FGL, HOSTAPERM PINK E from Hoechst, and CINQUASIA MAGENTA available from E.I. DuPont de Nemours & Company, and the like. Examples of magentas include, for example, 2,9-dimethyl substituted quinacridone and anthraquinone dye identified in the Color Index as CI 60710, CI Dispersed Red 15, diazo dye identified in the Color Index as CI 26050, CI Solvent Red 19, and the like or mixtures thereof. Illustrative examples of cyans include copper tetra(octadecyl sulfonamide) phthalocyanine, x-copper phthalocyanine pigment listed in the Color Index as CI74160, CI Pigment Blue, and Anthrathrene Blue identified in the Color Index as DI 69810, Special Blue X-2137, and the like or mixtures thereof. Illustrative examples of yellows that may be selected include diarylide yellow 3,3-dichlorobenzidene acetoacetanilides, a monoazo pigment identified in the Color Index as CI 12700, CI Solvent Yellow 16, a nitrophenyl amine sulfonamide identified in the Color Index as Foron Yellow SE/GLN, CI Dispersed Yellow 33 2,5-dimethoxy-4-sulfonanilide phenylazo-4′-chloro-2,4-dimethoxy acetoacetanilide, and Permanent Yellow FGL. Colored magnetites, such as mixtures of MAPICOBLACK and cyan components may also be selected as pigments.

Other useful colorants include, but are not limited to, Paliogen Violet 5100 and 5890 (BASF), Normandy Magenta RD-2400 (Paul Uhlrich), Permanent Violet VT2645 (Paul Uhlrich), Heliogen Green L8730 (BASF), Argyle Green XP-111-S (Paul Uhlrich), Brilliant Green Toner GR 0991 (Paul Uhlrich), Lithol Scarlet D3700 (BASF), Toluidine Red (Aldrich), Scarlet for Thermoplast NSD Red (Aldrich), Lithol Rubine Toner (Paul Uhlrich), Lithol Scarlet 4440, NBD 3700 (BASF), Bon Red C (Dominion Color), Royal Brilliant Red RD-8192 (Paul Uhlrich), Oracet Pink RF (Ciba Geigy), Paliogen Red 3340 and 3871K (BASF), Lithol Fast Scarlet L4300 (BASF), Heliogen Blue D6840, D7080, K7090, K6910 and L7020 (BASF), Sudan Blue OS (BASF), Neopen Blue FF4012 (BASF), PV Fast Blue B2G01 (American Hoechst), Irgalite Blue BCA (Ciba Geigy), Paliogen Blue 6470 (BASF), Sudan II, III and IV (Matheson, Coleman, Bell), Sudan Orange (Aldrich), Sudan Orange 220 (BASF), Paliogen Orange 3040 (BASF), Ortho Orange OR 2673 (Paul Uhlrich), Paliogen Yellow 152 and 1560 (BASF), Lithol Fast Yellow 0991K (BASF), Paliotol Yellow 1840 (BASF), Novaperm Yellow FGL (Hoechst), Permanerit Yellow YE 0305 (Paul Uhlrich), Lumogen Yellow D0790 (BASF), Suco-Gelb 1250 (BASF), Suco-Yellow D1355 (BASF), Suco Fast Yellow D 165, D1355 and D1351 (BASF), Hostaperm Pink E (Hoechst), Fanal Pink D4830 (BASF), Cinquasia Magenta (DuPont), and the like.

Coagulant

In embodiments, the coagulants used in the present process comprises know components, such as poly metal halides, for example poly aluminum halides, such as polyaluminum chloride (PAC) or polyaluminum sulfo silicate (PASS). For example, in one embodiment, the coagulants provide a final toner having a metal content of, for example, about 400 to about 10,000 parts per million. In another embodiment, the coagulant comprises a poly aluminum chloride providing a final toner having an aluminum content of about 400 to about 10,000 parts per million, such as about 400 to about 1,000 parts per million. In embodiments, the coagulant can be present in the toner particles, exclusive of external additives and on a dry weight basis, in amounts of from 0 to about 5% by weight of the toner particles, such as from about greater than 0 to about 3% by weight of the toner particles.

Toner Particle Preparation

The toner composition is, in embodiments, prepared by an emulsion/aggregation process, such as an emulsion/aggregation/coalescing process. For example, emulsion/aggregation/coalescing processes for the preparation of toners are illustrated in a number of Xerox patents, the disclosures of each of which are totally incorporated herein by reference, such as U.S. Pat. Nos. 5,290,654, 5,278,020, 5,308,734, 5,370,963, 5,344,738, 5,403,693, 5,418,108, 5,364,729, and 5,346,797. Also of interest are U.S. Pat. Nos. 5,348,832; 5,405,728; 5,366,841; 5,496,676; 5,527,658; 5,585,215; 5,650,255; 5,650,256; 5,501,935; 5,723,253; 5,744,520; 5,763,133; 5,766,818; 5,747,215; 5,827,633; 5,853,944; 5,804,349; 5,840,462; 5,869,215; 5,863,698; 5,902,710; 5,910,387; 5,916,725; 5,919,595; 5,925,488; and 5,977,210, the disclosures of each of which are hereby totally incorporated herein by reference. In addition, Xerox patents 6,627,373; 6,656,657; 6,617,092; 6,638,677; 6,576,389; 6,664,017; 6,656,658; and 6,673,505 are each hereby totally incorporated herein by reference. The appropriate components and process aspects of each of the foregoing U.S. Patents may be selected for the present composition and process in embodiments thereof.

In embodiments, the toner preparation process comprises forming a toner particle by mixing the high molecular weight non cross linked latex with a wax and a colorant dispersion, to which is added a coagulant of for example, a poly metal halide such as polyaluminum chloride while blending at high speeds such as with a polytron. The resulting mixture having a pH of about 2 to about 3 is aggregated by heating to a temperature below about the resin Tg to provide toner size aggregates. Additional high molecular weight non cross linked latex (which may be the same as or different from the first high molecular weight non cross linked latex, as described above) is added to the formed aggregates providing a shell over the formed aggregates. For example, in embodiments, about 10% to about 35% or about 15% to about 30% additional high molecular weight non cross linked latex can be added to the formed aggregates providing a shell over the formed aggregates. The pH of the mixture is then changed by the addition of a sodium hydroxide solution until a pH of about 7 is achieved. When the mixture reaches a pH of about 7, the carboxylic acid becomes ionized to provide additional negative charge on the aggregates thereby providing stability and preventing the particles from further growth or an increase in the size distribution when heated above the Tg of the latex resin. The temperature of the mixture is then raised to about 95° C. After about 30 minutes, the pH of the mixture is reduced to a value sufficient to coalesce or fuse the aggregates to provide a composite particle upon further heating such as about 4.5. The fused particles can be measured for shape factor or circularity, such as with a Sysmex FPIA 2100 analyzer, until the desired shape is achieved.

The mixture can be allowed to cool to room temperature (about 20° C. to about 25° C.) and can optionally be washed. When the mixture is to be washed, a multiple-step wash procedure can be used, where a first wash is conducted such as at a pH of about 10 and a temperature of about 63° C. followed by a deionized water (DIW) wash at room temperature. This can then be followed by a wash at a pH of about 4.0 at a temperature of about 40° C. followed by a final DIW water wash. The toner can then be dried.

The final toner composition comprises toner particles having a high molecular weight non cross linked resin, a wax, and a colorant. While not wishing to be bound by theory, in the present toner composition comprising a high molecular weight non cross linked latex, a wax, and a colorant, the high molecular weight resin is primarily used to increase the hot offset, lower the minimum fixing temperature (MFT), and provide low gloss properties such as from about 1 to about 20 gloss units, while the wax is used to provide release characteristics. The ratio of the high molecular weight non cross linked latex to the wax content and the colorant content are selected to control the rheology of the toner.

In embodiments, the final toner composition has a gloss, measured at the minimum fixing temperature, of from about 1 to about 20 gloss units, such as from about 2 or about 5 to about 10 or about 15 gloss units as measured on a BYK 75 degree micro gloss meter. “Gloss units” refers to Gardner Gloss Units measured on plain paper (such as Xerox 90 gsm COLOR XPRESSIONS+ paper or Xerox 4024 paper). Crease fix MFT is measured by folding images that have been fused over a wide range of fusing temperatures and then rolling a defined mass across the folded area. The print can also be folded using a commercially available folder such as the Duplo D-590 paper folder. The sheets of paper are then unfolded and toner that has been fractured from the sheet of paper is wiped from the surface. Comparison of the fractured area is then made to an internal reference chart. Smaller fractured areas indicate better toner adhesion and the temperature required to achieve acceptable adhesion is defined as the crease fix MFT.

In embodiments, the toner comprises high molecular weight non cross linked resin, wax, and colorant in an amount of about 68% to about 91% high molecular weight non cross linked resin, about 4% to about 15% wax, and about 5% to about 13% colorant, by weight based upon the total weight of the composition wherein a total of the components is about 100%, although not limited thereto. In embodiments, the high molecular weight non cross linked resin, the wax, and the colorant are present in an amount of about 81% high molecular weight non cross linked resin, about 9% wax, and about 10% colorant, by weight based upon the total weight of the composition.

In embodiments of the present toner composition, the resultant toner possesses a shape factor of about 120 to about 140 where a shape factor of 100 is considered to be spherical, and a particle circularity of about 0.900 to about 0.980 such as about 0.930 to about 0.980 as measured on an analyzer such as a Sysmex FPIA 2100 analyzer, where a circularity of 1.00 is considered to be spherical in shape.

In some embodiments, the toner composition can be a black toner composition. In embodiments, the black toner composition can have a Tg (onset) of from about 50 to about 60° C., a shape factor of about 120 to about 140, and a circularity of about 0.900 to about 0.980. In other embodiments, the toner composition can include a high Mw non crosslinked resin that comprises of styrene:butylacrylate:Beta-CEA in the ratio of about 72:28:3 pph by weigh of monomer. In other embodiments, the toner composition can include an optional amount of a crosslinked resin that comprises styrene:butylacrylate:Beta-CEA:DVB (divinyl benzene) in the ratio of about 65:53:3:1 pph by weight of monomer.

The toner particles can optionally be blended with external additives following formation. Any suitable surface additives may be used in embodiments. Suitable external additives include, for example, SiO₂, metal oxides such as TiO₂ and aluminum oxide, lubricating agent such as metal salts of fatty acids (such as zinc stearate or calcium stearate), long chain alcohols such as UNILIN®T 700, and the like. In general, silica is applied to the toner surface for toner flow, tribo enhancement, admix control, improved development and transfer stability and higher toner blocking temperature. TiO₂ is applied for improved relative humidity (RH) stability, tribo control and improved development and transfer stability. Zinc stearate is applied to provide lubricating properties. Zinc stearate provides developer conductivity and tribo enhancement, both due to its lubricating nature. The external surface additives can be used with or without a coating.

In embodiments, the toners contain from, for example, about 0.1 to about 5 weight percent titania and/or other metal oxides, about 0.1 to about 8 weight percent silica, and about 0.1 to about 4 weight percent zinc stearate or other metal stearates.

The toner particles of the disclosure can optionally be formulated into a developer composition by mixing the toner particles with carrier particles. Illustrative examples of carrier particles that can be selected for mixing with the toner composition prepared in accordance with the present disclosure include those particles that are capable of triboelectrically obtaining a charge of opposite polarity to that of the toner particles. Accordingly, in one embodiment the carrier particles may be selected so as to be of a negative polarity in order that the toner particles that are positively charged will adhere to and surround the carrier particles. Illustrative examples of such carrier particles include iron, iron alloys, steel, nickel, iron ferrites, including ferrites that incorporate strontium, magnesium, manganese, copper, zinc, and the like, magnetites, and the like. Additionally, there can be selected as carrier particles nickel berry carriers as disclosed in U.S. Pat. No. 3,847,604, the entire disclosure of which is totally incorporated herein by reference, comprised of nodular carrier beads of nickel, characterized by surfaces of reoccurring recesses and protrusions thereby providing particles with a relatively large external area. Other carriers are disclosed in U.S. Pat. Nos. 4,937,166 and 4,935,326, the disclosures of which are totally incorporated herein by reference.

The selected carrier particles can be used with or without a coating, the coating generally being comprised of acrylic and methacrylic polymers, such as methyl methacrylate, acrylic and methacrylic copolymers with fluoropolymers or with monoalkyl or dialkylamines, fluoropolymers, polyolefins, polystyrenes, such as polyvinylidene fluoride resins, terpolymers of styrene, methyl methacrylate, and a silane, such as triethoxy silane, tetrafluoroethylenes, other known coatings and the like.

The carrier particles can be mixed with the toner particles in various suitable combinations. The toner concentration is usually about 2% to about 10% by weight of toner and about 90% to about 98% by weight of carrier. However, different toner and carrier percentages may be used to achieve a developer composition with desired characteristics.

Toners of the present disclosure can be used in electrostatographic (including electrophotographic) imaging methods. Thus for example, the toners or developers of the disclosure can be charged, such as triboelectrically, and applied to an oppositely charged latent image on an imaging member such as a photoreceptor or ionographic receiver. The resultant toner image can then be transferred, either directly or via an intermediate transport member, to a support such as paper or a transparency sheet. The toner image can then be fused to the support by application of heat and/or pressure, for example with a heated fuser roll.

It is envisioned that the toners of the present disclosure may be used in any suitable procedure for forming an image with a toner, including in applications other than xerographic applications.

An example is set forth hereinbelow and is illustrative of different compositions and conditions that can be utilized in practicing the disclosure. All proportions are by weight unless otherwise indicated. It will be apparent, however, that the disclosure can be practiced with many types of compositions and can have many different uses in accordance with the disclosure above and as pointed out hereinafter.

### EXAMPLES

Preparation of Non-Crosslinked High Mw Latex:

A latex emulsion comprised of polymer particles generated from the emulsion polymerization of styrene, n-butyl acrylate and beta-CEA was prepared as follows. A surfactant solution consisting of 0.8 grams Dowfax 2A1 (anionic emulsifier) and 514 grams de-ionized water was prepared by mixing for 10 minutes in a stainless steel holding tank. The holding tank was then purged with nitrogen for 5 minutes before transferring into the reactor. The reactor was then continuously purged with nitrogen while being stirred at 300 RPM. The reactor was then heated up to 76° C. at a controlled rate, and held there. Separately, 8.1 grams of ammonium persulfate initiator was dissolved in 45 grams of de-ionized water.

Separately, the monomer emulsion was prepared in the following manner. 388.8 grams of styrene, 151.2 grams of butyl acrylate and 16.2 grams of O-CEA, 2.16 grams of 1-dodecanethiol, 1.89 grams of 1,10-decanediol diacrylate (ADOD), 10.69 grams of Dowfax 2A1 (anionic surfactant), and 257 grams of deionized water were mixed to form an emulsion. 1% of the above emulsion is then slowly fed into the reactor containing the aqueous surfactant phase at 76° C. to form the “seeds” while being purged with nitrogen. The initiator solution is then slowly charged into the reactor and after 10 minutes the rest of the emulsion is continuously fed in a using metering pump at a rate of 0.5%/min. Once all the monomer emulsion is charged into the main reactor, the temperature is held at 76° C. for an additional 2 hours to complete the reaction. Full cooling is then applied and the reactor temperature is reduced to 35° C. The product is collected into a holding tank. After drying, the latex the molecular properties were Mw=76,000, Mn=23,000 and the onset Tg was 51.2 deg C.

Preparation of Latex Gel:

A latex emulsion comprised of polymer gel particles generated from the semi-continuous emulsion polymerization of styrene, n-butyl acrylate, divinylbenzene, and Beta-CEA was prepared as follows. A surfactant solution consisting of 1.75 kilograms Neogen RK (anionic emulsifier) and 145.8 kilograms de-ionized water was prepared by mixing for 10 minutes in a stainless steel holding tank. The holding tank was then purged with nitrogen for 5 minutes before transferring into the reactor. The reactor was then continuously purged with nitrogen while being stirred at 300 RPM. The reactor was then heated up to 76° C. at a controlled rate and held constant. In a separate container, 1.24 kilograms of ammonium persulfate initiator was dissolved in 13.12 kilograms of de-ionized water. Also in a second separate container, the monomer emulsion was prepared in the following manner. 47.39 kilograms of styrene, 25.52 kilograms of n-butyl acrylate, 2.19 kilograms of β-CEA, and 729 grams of 55% grade divinylbenzene, 4.08 kilograms of Neogen RK (anionic surfactant), and 78.73 kilograms of deionized water were mixed to form an emulsion. The ratio of styrene monomer to n-butyl acrylate monomer by weight was 65 to 35 percent. One percent of the above emulsion is then slowly fed into the reactor containing the aqueous surfactant phase at 76° C. to form the “seeds” while being purged with nitrogen. The initiator solution is then slowly charged into the reactor and after 20 minutes the rest of the emulsion is continuously fed in using metering pumps.

Once all the monomer emulsion is charged into the main reactor, the temperature is held at 76° C. for an additional 2 hours to complete the reaction. Full cooling is then applied and the reactor temperature is reduced to 35° C. The product is collected into a holding tank after filtration through a 1 micron filter bag. After drying a portion of the latex the molecular properties were measured to be Mw=134,700, Mn=27,300 and the onset Tg was 43.0° C. The average particle size of the latex as measured by Disc Centrifuge was 48 nanometers and residual monomer as measured by GC as <50 ppm for styrene and <100 ppm for n-butyl acrylate.

### Example 1

### Preparation of Toner, High Mw, No Gel

265.3 grams of the non-crosslinked high Mw latex having a solids loading of 40.9 weight % and 61.36 grams of a wax emulsion (Polywax 850®) having a solids loading of 30.07 weight %, are added to 566.3 grams of deionized water in a vessel and stirred using an IKA Ultra Turrax® T50 homogenizer operating at 4,000 rpm. Thereafter, 126.71 grams of black pigment dispersion Sun Pigment WA1945 (Regal 330) having a solids loading of 17 weight %, and 11.01 grams of a 1 weight % calcium chloride solution is added to the above mixture followed by drop-wise addition of 34.0 grams of a flocculent mixture containing 3.4 grams polyaluminum chloride mixture and 30.6 grams 0.02 molar nitric acid solution. As the flocculent mixture is added drop-wise, the homogenizer speed is increased to 5,200 rpm and homogenized for an additional 5 minutes. Thereafter, the mixture is heated at 1° C. per minute to a temperature of 49° C. and held there for a period of about 1.5 to about 2 hours resulting in a volume average particle diameter of 5 microns as measured with a Coulter Counter. During heat up period, the stirrer is run at about 250 rpm and 10 minutes after the set temperature of 49° C. is reached, the stirrer speed is reduced to about 220 rpm. Additional 140.2 grams of the non-crosslinked high Mw latex is added to the reactor mixture and allowed to aggregate for an additional period of about 30 minutes at 49° C. resulting in a volume average particle diameter of about 5.7 microns. Adjusting the reactor mixture pH to 7 with 1.0 M sodium hydroxide solution freezes the particle size. Thereafter, the reactor mixture is heated at 1° C. per minute to a temperature of 95° C., followed by adjusting the reactor mixture pH to 4.0 with 0.3 M nitric acid solution. Following this, the reactor mixture is gently stirred at 95° C. for 5 hours to enable the particles to coalesce and spherodize. The reactor heater is then turned off and the reactor mixture is allowed to cool to room temperature at a rate of 1° C. per minute. The resulting toner mixture is comprised of about 16.7 percent toner, 0.25 percent anionic surfactant and about 82.9 percent by weight water. The toner of this mixture comprises about 81 percent styrene/acrylate polymer, about 10 percent Regal 330 pigment, about 9 percent by weight PW850 wax, and 150 ppm calcium chloride, and has a volume average particle diameter of about 5.7 microns and a GSD of about 1.19. The particles were washed 6 times, where the 1st wash was conducted at pH of 10 at 63° C., followed by 3 washes with deionized water at room temperature, one wash carried out at a pH of 4.0 at 40° C., and finally the last wash with deionized water at room temperature.

### Example 2

### Preparation of Toner, High Mw, With Gel

215.3 grams of the non-crosslinked high Mw latex having a solids loading of 40.9 weight % and 61.36 grams of a wax emulsion (Polywax 850®) having a solids loading of 30.07 weight %, are added to 529.7 grams of deionized water in a vessel and stirred using an IKA Ultra Turrax® T50 homogenizer operating at 4,000 rpm. Thereafter, 126.71 grams of black pigment dispersion Sun Pigment WA1945 (Regal 330) having a solids loading of 17 weight %, 83.3 grams of the above latex gel having a solids loading of 24 weight %, and 11.01 grams of a 1 weight % calcium chloride solution is added to the above mixture followed by drop-wise addition of 34.0 grams of a flocculent mixture containing 3.4 grams polyaluminum chloride mixture and 30.6 grams 0.02 molar nitric acid solution. As the flocculent mixture is added drop-wise, the homogenizer speed is increased to 5,200 rpm and homogenized for an additional 5 minutes. Thereafter, the mixture is heated at 1° C. per minute to a temperature of 49° C. and held there for a period of about 1.5 to about 2 hours resulting in a volume average particle diameter of 5 microns as measured with a Coulter Counter. During heat up period, the stirrer is run at about 250 rpm and 10 minutes after the set temperature of 49° C. is reached, the stirrer speed is reduced to about 220 rpm. Additional 140.2 grams of the non-crosslinked high Mw latex is added to the reactor mixture and allowed to aggregate for an additional period of about 30 minutes at 49° C. resulting in a volume average particle diameter of about 5.7 microns. Adjusting the reactor mixture pH to 7 with 1.0 M sodium hydroxide solution freezes the particle size. Thereafter, the reactor mixture is heated at 1° C. per minute to a temperature of 95° C., followed by adjusting the reactor mixture pH to 4.0 with 0.3 M nitric acid solution. Following this, the reactor mixture is gently stirred at 95° C. for 5 hours to enable the particles to coalesce and spherodize. The reactor heater is then turned off and the reactor mixture is allowed to cool to room temperature at a rate of 1° C. per minute. The resulting toner mixture is comprised of about 16.7 percent toner, 0.25 percent anionic surfactant and about 82.9 percent by weight water. The toner of this mixture comprises about 71 percent styrene/acrylate polymer, about 10 percent latex gel, about 10 percent Regal 330 pigment, about 9 percent by weight PW850 wax, and 150 ppm calcium chloride, and has a volume average particle diameter of about 5.8 microns and a GSD of about 1.19. The particles were washed 6 times, where the 1 st wash was conducted at pH of 10 at 63° C., followed by 3 washes with deionzed water at room temperature, one wash carried out at a pH of 4.0 at 40° C., and finally the last wash with deionized water at room temperature.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A toner composition comprising:
a resin substantially free of cross linking and having a weight average molecular weight of from about 50,000 to about 1,000,000;
a wax;
a colorant; and
a coagulant.

2. The toner composition of claim 1, wherein the resin has a weight average molecular weight of from about 55,000 to about 750,000.

3. The toner composition of claim 1, wherein the resin has a weight average molecular weight of from about 60,000 to about 500,000.

4. The toner composition of claim 1, wherein substantially free of cross linking is from about zero percent cross linking to about 10 percent cross linking.

5. The toner composition of claim 1, wherein substantially free of cross linking is from about zero percent cross linking to about 1 percent cross linking.

6. The toner composition of claim 1, wherein the toner composition is substantially free of resin having a weight average molecular weight of less than about 50,000.

7. The toner composition of claim 1, further comprising a crosslinked resin.

8. The toner composition of claim 1, wherein the toner composition comprises:
aggregated core particles comprising said resin substantially free of cross linking and having a weight average molecular weight of from about 50,000 to about 1,000,000, said wax, and said colorant; and
a shell formed over said aggregated core particles comprising additional resin substantially free of cross linking and having a weight average molecular weight of from about 50,000 to about 1,000,000.

9. The toner composition of claim 8, wherein said resin substantially free of cross linking and having a weight average molecular weight of from about 50,000 to about 1,000,000 and said additional resin substantially free of cross linking and having a weight average molecular weight of from about 50,000 to about 1,000,000 differ in at least one property selected from the group consisting of type of monomer content, amount of monomer content, weight average molecular weight, and glass transition temperature.

10. The toner composition of claim 1, wherein the resin substantially free of cross linking is selected from the group consisting of styrene acrylates, styrene methacrylates, butadienes, isoprene, acrylonitrile, acrylic acid, methacrylic acid, beta-carboxy ethyl acrylate, polyesters, poly(styrene-butadiene), poly(methyl styrene-butadiene), poly(methyl methacrylate-butadiene), poly(ethyl methacrylate-butadiene), poly(propyl methacrylate-butadiene), poly(butyl methacrylate-butadiene), poly(methyl acrylate-butadiene), poly(ethyl acrylate-butadiene), poly(propyl acrylate-butadiene), poly(butyl acrylate-butadiene), poly(styrene-isoprene), poly(methyl styrene-isoprene), poly(methyl methacrylate-isoprene), poly(ethyl methacrylate-isoprene), poly(propyl methacrylate-isoprene), poly(butyl methacrylate-isoprene), poly(methyl acrylate-isoprene), poly(ethyl acrylate-isoprene), poly(propyl acrylate-isoprene), poly(butyl acrylate-isoprene); poly(styrene-propyl acrylate), poly(styrene-butyl acrylate), poly(styrene-butadiene-acrylic acid), poly(styrene-butadiene-methacrylic acid), poly(styrene-butyl acrylate-acrylic acid), poly(styrene-butyl acrylate-methacrylic acid), poly(styrene-butyl acrylate-acrylonitrile), poly(styrene-butyl acrylate-acrylonitrile-acrylic acid), and styrene/butyl acrylate/carboxylic acid terpolymers, styrene/butyl acrylate/beta-carboxy ethyl acrylate terpolymers, and mixtures thereof.

11. The toner composition of claim 1, wherein the resin substantially free of cross linking comprises styrene:butylacrylate:beta-carboxy ethyl acrylate.

12. The toner composition of claim 1, having a gloss, measured at the minimum fixing temperature, of from about 1 to about 20 Gardner Gloss Units.

13. The toner composition of claim 1, wherein the wax is an alkylene wax present in an amount of about 6% to about 15% by weight based upon the total weight of the composition.

14. The toner composition of claim 1, wherein the wax is an alkylene, a polyethylene, a polypropylene, or mixtures thereof.

15. The toner composition of claim 1, wherein the colorant comprises a pigment, a dye, or mixtures thereof, in an amount of about 1% to about 25% by weight based upon the total weight of the composition.

16. The toner composition of claim 1, wherein the wax is in the form of a dispersion comprising a wax having a particle diameter of about 100 to about 500 nanometers, water, and an anionic surfactant.

17. The toner composition of claim 1, wherein the colorant comprises a pigment dispersion comprising pigment particles having a volume average diameter of about 50 to about 300 nanometers, water, and an anionic surfactant.

18. The toner composition of claim 1, wherein the coagulant is present in the toner composition, exclusive of external additives and on a dry weight basis, in an amount of from 0 to about 5% by weight of the toner composition.

19. The toner composition of claim 1, having a Tg (onset) of from about 50 to about 60° C., a shape factor of about 120 to about 140, and a circularity of about 0.900 to about 0.980.

20. A developer comprising:
the toner of claim 1, and
a carrier.

21. A toner process comprising:
mixing a resin substantially free of cross linking and having a weight average molecular weight of from about 50,000 to about 1,000,000, a wax, a colorant, and a coagulant to provide toner size aggregates;
optionally, adding additional resin substantially free of cross linking and having a weight average molecular weight of from about 50,000 to about 1,000,000 to the formed aggregates thereby providing a shell over the formed aggregates;
heating the aggregates to form toner; and
optionally, isolating the toner.

22. The toner process of claim 21, wherein the resin has a weight average molecular weight of from about 55,000 to about 750,000.

23. The toner process of claim 21, wherein the resin has a weight average molecular weight of from about 60,000 to about 500,000.

24. The toner process of claim 21, wherein said resin substantially free of cross linking and having a weight average molecular weight of from about 50,000 to about 1,000,000 and said additional resin substantially free of cross linking and having a weight average molecular weight of from about 50,000 to about 1,000,000 differ in at least one property selected from the group consisting of type of monomer content, amount of monomer content, weight average molecular weight, and glass transition temperature.

25. The toner process of claim 21, wherein the toner is substantially free of resin having a weight average molecular weight of less than about 50,000.

26. The toner process of claim 21, wherein the heating comprises a first heating below the glass transition temperature of the resin substantially free of cross linking and a second heating above the glass transition temperature of the resin substantially free of cross linking.

27. The toner process of claim 21, further comprising:
providing an anionic surfactant in an amount of about 0.01% to about 20% by weight based upon a total weight of the reaction mixture;
wherein the anionic surfactant is selected from the group consisting of sodium dodecylsulfate, sodium dodecylbenzene sulfonate, sodium dodecylnaphthalene sulfate, dialkyl benzenealkyl, sulfates, sulfonates, adipic acid, hexa decyldiphenyloxide disulfonate, or mixtures thereof.

28. A method of developing an image, comprising:
applying a toner composition to an image, the toner composition comprising a resin substantially free of cross linking and having a weight average molecular weight of from about 50,000 to about 1,000,000, a wax, a colorant, and a coagulant; and
fusing said toner composition to the substrate.
